(19) United States
(12) Patent Application Publication
(10) Pub. No.: US 2006/0194456 A1
(43) Pub. Date: Aug. 31, 2006

(54) Cutting board assembly and method

(76) Inventors: Brian W. Cawley, Garland, TX (US); Thomas A. Wolf II, Lowry Crossing, TX (US)

Correspondence Address: GRADY K. BERGEN, 3333 LEE PARKWAY, SUITE 600, DALLAS, TX, 75219, US

(21) Appl. No.: 11/067,869

(22) Filed: Feb. 28, 2005

(51) Int. Cl. H01R 12/00

(52) U.S. Cl. 439/74

(57) ABSTRACT

A cutting board assembly has a cutting board with at least one cutting surface. A cutting board receptacle is configured for mounting to a countertop having an upper surface. The receptacle defines a recess for closely receiving the cutting board to prevent substantial lateral movement therein and has a sufficient depth so that the at least one cutting surface of the cutting board is generally flush with the upper surface of the countertop when the cutting board is received within the recess. The receptacle removably receives the cutting board so that the cutting board may be selectively and readily removed and replaced within the recess of the receptacle.

### BACKGROUND

The present invention relates to cutting boards, such as those that may be used in food preparation and the like.

### BRIEF DESCRIPTION OF THE DRAWINGS

For a more complete understanding of the present invention, reference is now made to the following descriptions taken in conjunction with the accompanying figures, in which:

FIG. 1 is a top plan view of a cutting board receptacle, constructed in accordance with an embodiment of the present invention;

FIG. 2 is cross-sectional side view taken along the lines II-II of the receptacle of FIG. 1;

FIG. 3 is a top plan view of a cutting board assembly constructed in accordance with an embodiment of the present invention;

FIG. 4 is an enlarged cross-sectional view of the cutting board assembly of FIG. 3 taken along the lines IV-IV;

FIG. 5 is top plan view of a removable cutting board of the cutting board assembly of FIG. 3;

FIG. 6 is a cross-sectional of the cutting board of FIG. 5 taken along the lines VI-VI; and

FIG. 7 is a perspective view of the cutting board of FIG. 5 shown exploded away from a cutting board receptacle of the cutting board assembly of FIG. 3.

### DETAILED DESCRIPTION

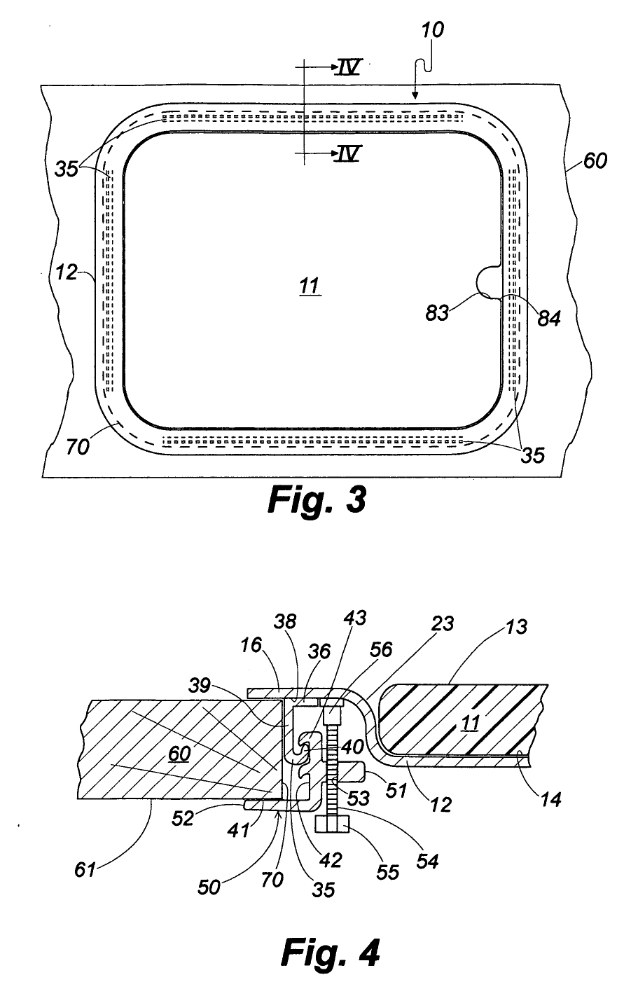

Referring to FIG. 3, a built-in countertop cutting board assembly 10 includes a removable cutting board 11 and a cutting board receptacle 12. As shown, the board 11 and receptacle 12 may each have a generally rectangular configuration, although they may have square, polygonal, round, oval or other non-rectangular shapes, as well. The cutting board 11 and the board receptacle 12 are shown having two opposite, generally parallel longitudinal side edges that are laterally spaced apart and two opposite, generally parallel lateral side edges that are longitudinally spaced apart.

The board 11 may be configured so that it is reversibly received within the receptacle 12. In this way, the opposite cutting surfaces 13, 14 (FIG. 4) may be flipped upside down so that the opposite cutting surfaces are alternately or selectively exposed or faces upward. Additionally, with respect to the rectangular configuration and other configurations, the board 11 may be received within the receptacle 12 without regard to the orientation of the side edges. Thus, in the case of a non-square, but rectangular cutting board, as is shown in FIG. 3, the cutting board 11 may be rotated 180 degrees without flipping the cutting board and still be received within the receptacle 12. The board 11 is merely placed into the receptacle 12 to provide a flush cutting surface in relation to the countertop.

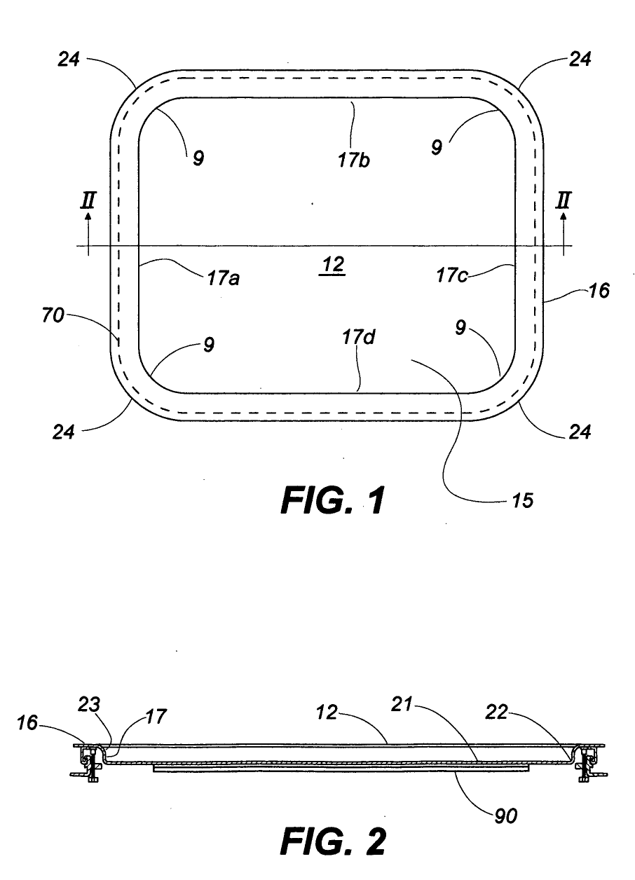

FIGS. 1-2 show the receptacle 12, which may be formed from one or more sheets of material. The receptacle 12 may include a stamped or molded interior portion or recess 15. As used herein, the terms “inwardly” and “outwardly” refer to directions toward and away from, respectively, the center of the receptacle 12. The terms “upper,” “upward,” “lower,” “bottom,” and similar expressions of orientation refer to the orientation of the receptacle 12 as it is shown in FIG. 2. The receptacle 12 may be provided with a bottom floor or panel 21. Extending upward from the periphery of the floor 21 is a sidewall 17, which may be a continuous sidewall formed from sidewall sections 17a-17d, as shown. The sidewall 17 may be joined to the floor 21 by a curved or arcuate portion, designated generally at 22 (FIG. 2).

In an alternate embodiment, the recess 15 of the receptacle 12 may be open, but be provided with an inwardly projecting peripheral lip or rim, or have inwardly projecting arms or other members upon which the peripheral portions of the cutting board 11 rests, or there may be an opening or openings in the floor 21 of the recess 15.

Extending from the upper extent of the sidewall 17 is an outwardly projecting flange 16. The flange 16 may be joined to the upper extent of the sidewall 17 by a curved or arcuate portion designated generally at 23, as shown.

The receptacle 12 may be formed from a 20 gauge stainless steel sheet. A suitable material is “201” stainless steel sheet in the annealed condition. Other stainless steel material, such as “430” stainless steel sheet, can also be used. A pre-finished stainless steel sheet may be used, although, a natural, brushed, bead-blasted, electro-polished, passivated, or sanded finish may be used. The receptacle 12 material may also be selected from other materials. Examples of such materials include, but are not limited to, aluminum, fiberglass, porcelain, carbon fiber, thermoplastics, iron, various sheet metals, polymeric materials, molded plastic material, etc. The board receptacle finish may be painted, powder-coated, or textured with various coatings of epoxies, urethanes, metal-flake, oil base paint, etc.

The dimensions of the receptacle 12 may vary, but in an example of one embodiment, the outside dimensions of the receptacle 12 are approximately (13.5 inches) in length, (11.125 inches) in width, with an outside corner radius 24 of (2.4 inches) on all four outside corners. The flange 16 may have a generally flat profile (FIG. 2), however, an open-bead, straight-trim, or tapered flange having a width of approximately one inch around the peripheral margin of the receptacle 12 may be used. As an example, the inside or interior dimensions of the recess 15 of the receptacle 12 may be approximately 11.75 inches in length, 9.375 inches in width, and have an inside corner radius 9 (FIG. 1) of 1.5 inches on all four inside corners. Further, in the example, the recess 15 may have a depth of about 0.5 inch.

It will be recognized by those of ordinary skill in the art that larger or smaller receptacles 12 having various configurations of differing dimensions, shapes and cross-sections are within the scope of the present invention. The depth of the recess 15 may vary depending upon the thickness of the cutting board 11 used. A suitable depth may be from about ¼ inch to about 1½ inches, which would generally correspond to the thickness of most cutting boards. The thickness of the stainless steel material may be from 22 gauge or greater in order to form the receptacle 12 to properly support the board 11 in accordance with the present invention.

The receptacle, such as the receptacle 12, may be formed from a single sheet of material (egs. stainless steel) by a deep draw process. This may be accomplished by shaping the material through a series of “draws” and stress-relieving anneals utilizing a draw punch and a movable draw die on a double action press, with a die cut to form the corresponding peripheral outside corner radius 24 in each of the four corners of the flange 16. The result is a completely seam-free, leak-free body of sufficient strength. Other methods of forming the receptacle, such as molding, etc., may also be used and may be dependent upon the type of material used, as will be appreciated by those skilled in the art.

The receptacle 12 may be provided with a channel member 35, shown in FIG. 4, which is an enlarged cross-sectional side view taken along lines IV-IV of FIG. 3, which illustrates the assembly mounted into a countertop aperture or opening. The channel member 35, hereafter referred to as the channel, has a generally L-shaped cross-section and has one arm 36 which is joined, such as with epoxy or other acceptable metal joining methods, to the undersurface of the flange 16 as shown at 38. The other arm 39 of the channel 35 is disposed generally perpendicular to the plane of the flange 16 and has a cooperating arcuate or hooked portion 40, hereafter referred to as channel hook, formed in its lower terminal end. The channel 35 may extend along generally the entire length of the sides of the receptacle 12. As an example of a practical embodiment of the present invention, the channels 35 may have dimensions of approximately 1.5 inches×0.75 inch×0.5 inches.

A lug 50 may be provided with the assembly for engagement with the channel members 35. The lug 50 may have a generally L-shaped cross-sectional configuration with a lower base portion 41 having an integral arm 42 that may extend generally upwardly and perpendicular to the plane of the base 41. The arm 42 may have an arcuate or hooked portion 43, hereafter referred to as lug hook, formed in its upper terminal end for engaging and cooperating with the channel hook 40. The lug hook 43 may be similar in configuration and shape to the channel hook 40 formed on the channel 35. The channel hook 40 and the lug hook 43 are configured to be coupled together so that force may be transmitted therethrough, as is described below.

In use, the base 41 of the lug 50 extends under the countertop 60 and engages the undersurface 61 of the countertop 60 adjacent to the countertop opening 70. The end 51 of the lug 50 remote from end 52 may be provided with a threaded aperture 53. A threaded screw 54 is threadedly received within the aperture 53. The screw 54 includes a slotted head 55 and has a cap 56 at its upper end, which may be of polymeric or plastic material, which may be brought into or out of contact with the underside of the flange 16 by rotation of the screw 54.

In reference to FIGS. 3-4, the installation of the receptacle 12 is accomplished by positioning the receptacle within the opening 70 of the countertop 60 so that the flanges 16 of the receptacle 12 overlay and rest or otherwise engage the periphery portions of the countertop 60 surrounding the opening 70. The receptacle 12 may be surrounded on all sides by portions of the countertop. The lug 50 is then positioned so that the lug hook 43 of the lug 50 engages the channel hook 40 of the channel 35. The lug 50 is arranged so that the cap 56 of the screw 54 may be brought into contact with the underside of the flange 16. Continued clockwise rotation of the screw 54 causes the receptacle 12 to be tightly clamped to the countertop 60 and a seal to be formed between the underside of the flange 16 and the upper surface of the countertop 60. A gasket material may be optionally used between the upper surface of the countertop 60 and the underside of the flange 16. The receptacle 12 may be removed from the countertop 60 by simply rotating the screw 54 in a counter clockwise direction until the cap 56 is moved out of contact with the underside of the flange 16, and thereafter removing the lug hook 43 of the lug 50 from engagement with the channel hook 40 of the channel 35.

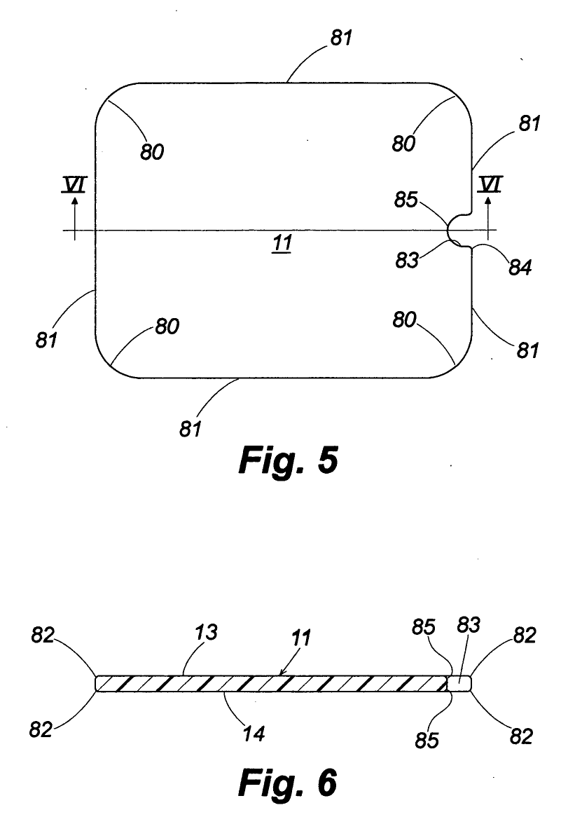

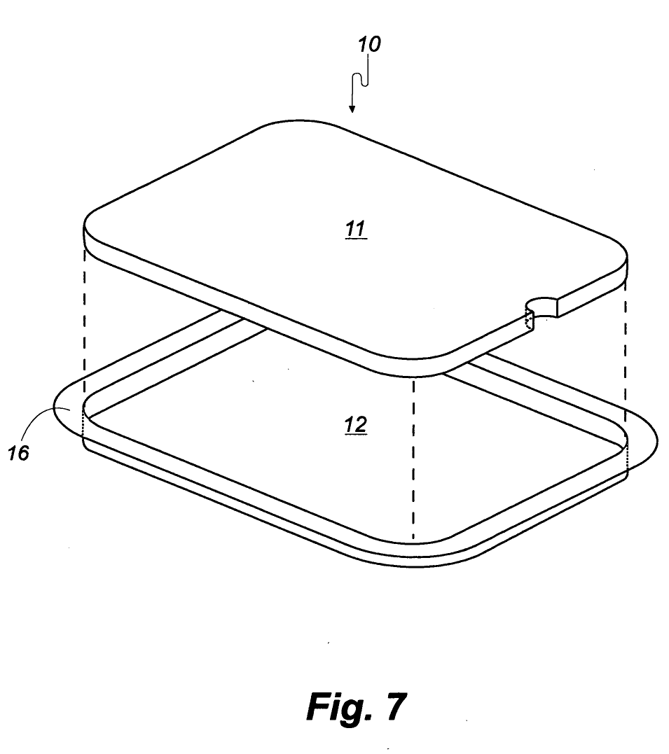

Referring to FIGS. 5-6, the cutting board 11 may be formed from a solid piece of material. The thickness of the material may range, for example, from about ¼ inch to about 1½ inches. In the example shown, the cutting board has a thickness of about ½ inch. The cutting board 11 may be formed from a variety of different materials, such as wood, including laminated and ingrained wood, particle board, stone (egs. marble, granite, etc.), ceramics, and synthetic plastic or polymeric materials, such as polyethylene, polypropylene, etc. Examples of commercially available material includes CORIAN®, available from Dupont; RICHLITE® wood-fiber composite laminate, available from Rainier Plywood Company; SANI-TUFF® rubber cutting boards, available from Teknor Apex Company; SILESTONE® materials, available from Cosentino International; and ARLITE™ engineered stone. The material is formed to generally correspond in size and shape to the shape of the recess 15 of the receptacle 12. In the example, the board 11 has rounded corners 80 with a corner radius 80 of 1.45 inches corresponding to the inside corner radius 9 in the recess 15 of the receptacle 12. The board side edges 81 may also be rounded around the entire peripheral of the board 11 on corners 81, which may have a radius of 0.125 inches in the example. The board 11 may also be optionally provided with a grasping portion 83, which may be in the form of a finger notch, hole, handle or other grasping device to facilitate removal. This may be provided generally along one side edge, as is shown. Alternatively, a grasping portion, which may be in the form of a notch or recess (not shown) formed in the receptacle flange 16 may also be used to facilitate removal.

The opposite cutting surfaces 13, 14 may be the same or different. They may be provided with different surface finishes to provide different appearances, or be provided with various grooves, slots or raised or recessed portions and other textures, if desired. The cutting board 11 may be formed from two or more different materials to form the different cutting surfaces 13, 14. The cutting board 11 may be formed from materials that resist stains, odors, bacteria, and germs, and that are dishwasher safe and that are easily replaceable or renewable. The board 11 is designed for food preparation, but it may be used as a serving tray as well. One can place hors d'oeuvres, cheeses, vegetables, fruits, deserts, or candies on the cutting board and keep in the refrigerator to stay cool for serving.

As shown in FIG. 2, a heat exchange element 90 may be provided with the receptacle 12. The element 90 may be in contact with the undersurface of the receptacle floor 21. The element may be in the form of a cooling or heating element for selectively heating or cooling the floor 21. The element 90 may also include a layer of insulating material that reduces heat transfer to or from the receptacle 12 to the cutting board 11. Thus, the board 11 can be chilled, such as by placing the board 11 in a freezer and then placing it in the receptacle 12 for mixing and blending ice creams with fruits or candies on a secure frozen surface. A trivet (not shown), such as a cast iron trivet, having feet or support members to suspend a holding portion of the trivet, may also be configured and placed in the receptacle 12 to protect surfaces from hot pots and other items, to allow the items to cool.

To install the cutting board assembly 10, the opening 70 is cut or otherwise provided in the countertop 60. The receptacle 12 is positioned within the opening 70 and a number of the anchoring lugs 50 are used to engage the channels 35, as described previously. The set screws 54 are adjusted to an adequate torque to secure the receptacle 12 within the hole 70 of the countertop 60. If desired, a silicone or resilient caulking compound or a gasket may be provided to seal the underside 63 of the flange 16 with the countertop 60 to ensure a watertight seal.

The invention permits a self-rimming receptacle 12 to be utilized with a removable cutting board 11 and eliminates the need to use a rim or trim ring which heretofore has been used to mount permanent built-in cutting boards. In such prior art devices, the rim or trim ring overlays the cutting board and must be removed or the mounting assembly loosened or otherwise modified to allow the built-in cutting board to be removed.

The design of the present invention allows relatively easy mounting of the cutting board assembly 10. The cutting board 11 can be readily removed and replaced within the recess of the receptacle 12 without modifying the receptacle or requiring substantial manipulation of the receptacle or the countertop. This is distinguishable from prior art countertops where a portion of the countertop itself may be used as a cutting board and in which the entire countertop portion itself may be removed and replaced. As used herein, the expressions “readily removed” or without requiring “substantial manipulation” is meant to encompass the situation where the cutting board may be simply lifted and removed within a second or two with no cutting, bending, disassembly, unbolting, unscrewing or other modification of the receptacle, countertop or cutting board being required other than the manipulation of an operable release mechanism or latch (not shown) that engages the cutting board, which may optionally be provided to facilitate selective holding of the cutting board within the recess 15.

The cutting board assembly permits the removable cutting board 11 to be provided in a countertop in a sunken configuration wherein the exposed cutting surface of the cutting board is generally flush with the surface of the countertop. As used herein, the expression “generally flush” may be construed to mean generally parallel and may encompass slightly raised or lowered relative positions (egs. <¼ or <⅜ inch) with respect to the cutting surface of the cutting board and surface of the countertop, while still providing an overall flush appearance.

The receptacle 12 provides a finished, rimmed appearance, as in permanently mounted cutting boards. Although it is envisioned that the cutting board assembly 10 would be used in kitchens and other areas used for the preparation of food, it could also be mounted in a vanity or other similar surfaces. As used herein, the term “countertop” is meant to encompass those generally waist-level work surface areas of kitchen cabinetry and the like, but may also include any other similar structure or surface that may be used for the preparation or handling of food or other items.

The built-in countertop cutting board assembly 10 provides a readily removable cutting board where food can be cut with the assembly 10 mounted flush to the countertop 60. The receptacle 12 secures the board 11 to prevent substantial lateral movement of the cutting board during performance of cutting operations when positioned within the recess 15, and while allowing easy access and removal of the board 11 from the receptacle 12. The cutting board may be easily removed, be placed in the sink or dishwasher for cleaning or sanitizing of the board 11, and then easily replaced within the receptacle. Several cutting boards, that may be the same or different (egs. different color, design, material, etc.), may be provided with the assembly to provide a different appearance or to replace a removed cutting board, such as when it is being cleaned or used as a serving tray. The assembly may also be used as an alternative to complete countertop replacement or for resurfacing of a damaged countertop.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. A cutting board assembly comprising:
a cutting board with at least one cutting surface;
a cutting board receptacle configured for mounting to a countertop having an upper surface, the receptacle defining a recess for closely receiving the cutting board to prevent substantial lateral movement therein and having a sufficient depth so that the at least one cutting surface of the cutting board is generally flush with the upper surface of the countertop when the cutting board is received within the recess, and wherein the receptacle removably receives the cutting board so that the cutting board may be selectively and readily removed and replaced within the recess of the receptacle.

2. The cutting board assembly of claim 1, wherein:
at least one of the cutting board and receptacle is provided with a grasping portion to facilitate removal of the cutting board from the receptacle.

3. The cutting board assembly of claim 1, wherein:
the receptacle is configured for being received within an opening of the countertop and includes an outwardly projecting flange that overlays and engages the periphery portions of the countertop that define the opening.

4. The cutting board assembly of claim 1, wherein:
the receptacle has a bottom portion that generally coextends with the cutting board.

5. The cutting board assembly of claim 1, wherein:
the recess of the receptacle is open.

6. The cutting board assembly of claim 1, wherein:
the cutting board has a thickness of from about ¼ inch to about 1½ inches.

7. The cutting board assembly of claim 1, wherein:
the receptacle is insulated to reduce heat transfer to or from the cutting board.

8. The cutting board assembly of claim 1, wherein:
the cutting board is reversibly received within the receptacle so that opposite facing cutting surfaces of the cutting board may be selectively exposed when received within the receptacle.

9. The cutting board assembly of claim 1, wherein:
the receptacle is providing with at least one of a cooling element or heating element for cooling or heating of the cutting board.

10. A cutting board assembly comprising:
a countertop having a non-sink opening formed therein, the countertop having a generally planar upper surface;
a cutting board having at least one generally flat cutting surface;
a cutting board receptacle mounted within the opening of the countertop, the receptacle defining a recess for closely receiving the cutting board to prevent substantial lateral movement therein and having a sufficient depth so that the at least one cutting surface of the cutting board is generally flush with the upper surface of the countertop when the cutting board is received within the recess, and wherein the receptacle removably receives the cutting board so that the cutting board may be selectively and readily removed and replaced within the recess of the receptacle.

11. The cutting board assembly of claim 10, wherein:
at least one of the cutting board and receptacle is provided with a grasping portion to facilitate removal of the cutting board from the receptacle.

12. The cutting board assembly of claim 10, wherein:
the receptacle is configured for being received within an opening of the countertop and includes an outwardly projecting flange that overlays and engages the periphery portions of the countertop that define the opening.

13. The cutting board assembly of claim 10, wherein:
the receptacle has a bottom portion that generally coextends with the cutting board.

14. The cutting board assembly of claim 10, wherein:
the recess of the receptacle is open.

15. The cutting board assembly of claim 10, wherein:
the cutting board has a thickness of from about ¼ inch to about 1½ inches.

16. The cutting board assembly of claim 10, wherein:
the receptacle is insulated to reduce heat transfer to or from the cutting board.

17. The cutting board assembly of claim 10, wherein:
the receptacle is providing with at least one of a cooling element or heating element for cooling or heating of the cutting board.

18. The cutting board assembly of claim 10, wherein:
the cutting board is reversibly received within the receptacle so that opposite facing cutting surfaces of the cutting board may be selectively exposed when received within the receptacle.

19. A method of using a cutting board comprising:
providing a non-sink opening in a countertop, the countertop having an upper surface;
mounting a cutting board receptacle within the opening of the countertop, the receptacle defining a recess;
positioning a cutting board having at least one cutting surface within the recess, the recess closely receiving the cutting board to prevent substantial lateral movement therein and having a sufficient depth so that the at least one cutting surface of cutting board is exposed and generally flush with the upper surface of the countertop when the cutting board is received within the recess;
removing the cutting board from the recess without modifying or substantially manipulating the cutting board receptacle or the countertop.

20. The method of claim 18, further comprising:
repositioning the cutting board within the recess so that a second cutting surface is exposed.
